(19) United States
(12) Patent Application Publication
(10) Pub. No.: US 2012/0042181 A1
(43) Pub. Date: Feb. 16, 2012

(54) Always-On System For Uninterrupted Power Supply

(76) Inventor: Kuo-Hsien KUO, Taichung City (TW)

(21) Appl. No.: 13/282,201

(22) Filed: Oct. 26, 2011

Related U.S. Application Data
(63) Continuation-in-part of application No. 11/841,656, filed on Aug. 20, 2007.

(51) Int. Cl. G06F 1/26

(52) U.S. Cl. 713/300

(57) ABSTRACT

This invention relates to an always-on uninterrupted power supply system mainly provided with a control unit to govern a power supply switch unit. When one of main power supply units or a bypass power supply unit of an external power device is to be installed or uninstalled for maintenance, a user can operate the control unit to enable the power supply switch unit to switch to the main power supply unit or the bypass power supply unit that is not to be installed or uninstalled to provide power for loads connected with the always-on uninterrupted power supply system to operate continuously, without interrupting the normal operation of the load.

The current application is a continuation-in-part of, and claims a priority to U.S. Ser. No. 11/841,656 filed on Aug. 20, 2007.

### BACKGROUND OF THE INVENTION

1. Field of the Invention

This invention relates to a system for uninterrupted power supply, particularly to one being able to supply power to those electric loads connected to the system to continuously supplied with power without being interrupted.

2. Description of the Prior Art

It is known that people rely more and more on information technology products in their daily life and there is always a demand for a stable power supply to those products. FIG. 1 shows a block diagram of a conventional way in electric circuit of a load 1. A conventional uninterruptible power system 3, generally referred as a UPS, is connected between the load 1 and the external power supply 2 so as to enable the load 1 can be normally shut down with sufficient time because of a sudden break down of an external power supply 2. The load 1 can be booted again as soon as the external power supply 2 is restored to supply power. However, if the interruptible power system 3 is out of function and becoming functional abnormal and have to be disassembled for a repair, it can not be disconnected until the load 1 is completely shut down. In addition, the load 1 must be connected to another external power supply or other spare power supply before the interruptible power system 3 is repaired if the load 1 has to be operated continuously. It is apparently to see the load 1 has to be switched OFF and resumed ON during an unexpected power failure. There was no system to supply electric power to a load continuously even when a UPS is out of function or in need of maintenance. Therefore, by using a conventional UPS 3 may cause not only inconvenience to a user, but also a raise of cost and a waste of time by interruption of the normal operation of the load.

In U.S. Pat. No. 6,191,500, there is disclosed a system for providing uninterrupted power supply to a critical load. In the disclosure, the system contains two power uninterrupted modules to make sure the output powers from them can be combined with one another to provide a sufficient source of power to the critical load regardless of the phase difference. This invention has no teachings on if one of the modules is out of function and to be uninstalled. Therefore, it still can not meet the demand to permanently and continuously having power to be supplied to the load.

### SUMMARY OF THE INVENTION

It is therefore the primary object of the present invention to provide a system for uninterrupted power supply to a load when the UPS units is out of function or in need of uninstallation to continuously supply power to the connected load.

The main advantage of the system for uninterrupted power supply is to save time and inconvenience of the users without being interrupted during the UPS unit is to be uninstalled.

Another object of the present invention is to provide an always-on system so that the power supply to the load is always on without any interruption.

It is therefore the system for uninterrupted power supply according to the present invention comprises mainly a control unit to govern a power supply switch unit. The external power device has a main power supply unit and a bypass power supply unit. When the external power device is to be installed or uninstalled, the control unit can transmit an enabling signal to a power supply switch unit which being orderly connected with a protection circuit unit and a power supply input unit so as to select a main power supply input terminal or a bypass power supply input terminal of the power supply input unit to provide power for the system to keep loads connected with the always-on system continuing to work without being affected by installing or uninstalling the external power device.

### BRIEF DESCRIPTION OF DRAWINGS

This invention is better understood by referring to the accompanying drawings, wherein:

FIG. 1 is a block diagram of a conventional connecting system relating to an external power supply, an uninterruptible power system (UPS) and a load;

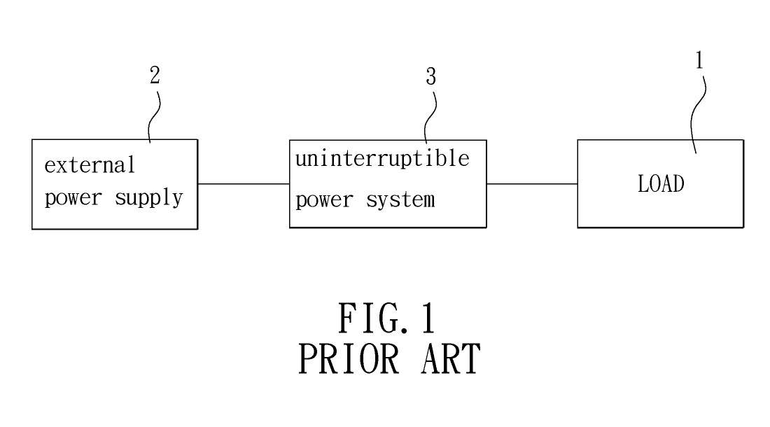

FIG. 2 is a simplified block diagram of a circuit connection used in a preferred embodiment of the always-on uninterrupted power system according to the present invention;

FIG. 3 is a block diagram of an electric circuit of the preferred embodiment of an always-on uninterrupted power system according to the present invention;

FIG. 4 is an illustrative diagram showing the always on uninterrupted power system according to the present invention being connected to various power loads; and

FIG. 5 is a schematic circuit diagram of the always on uninterrupted power system according to the present invention.

### DETAILED DESCRIPTION OF THE PREFERRED EMBODIMENT

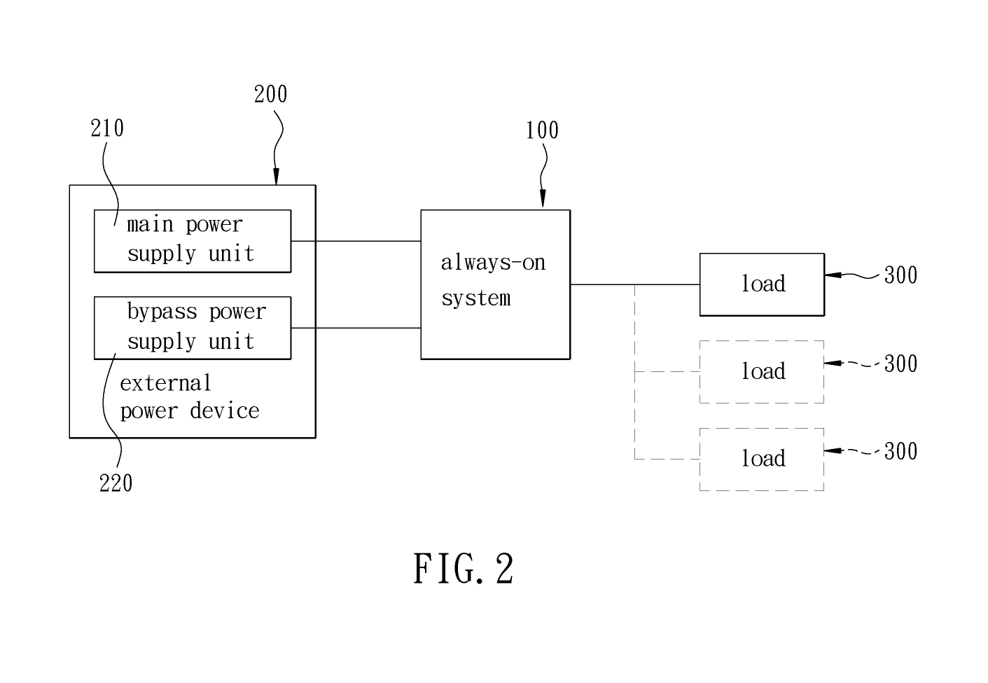

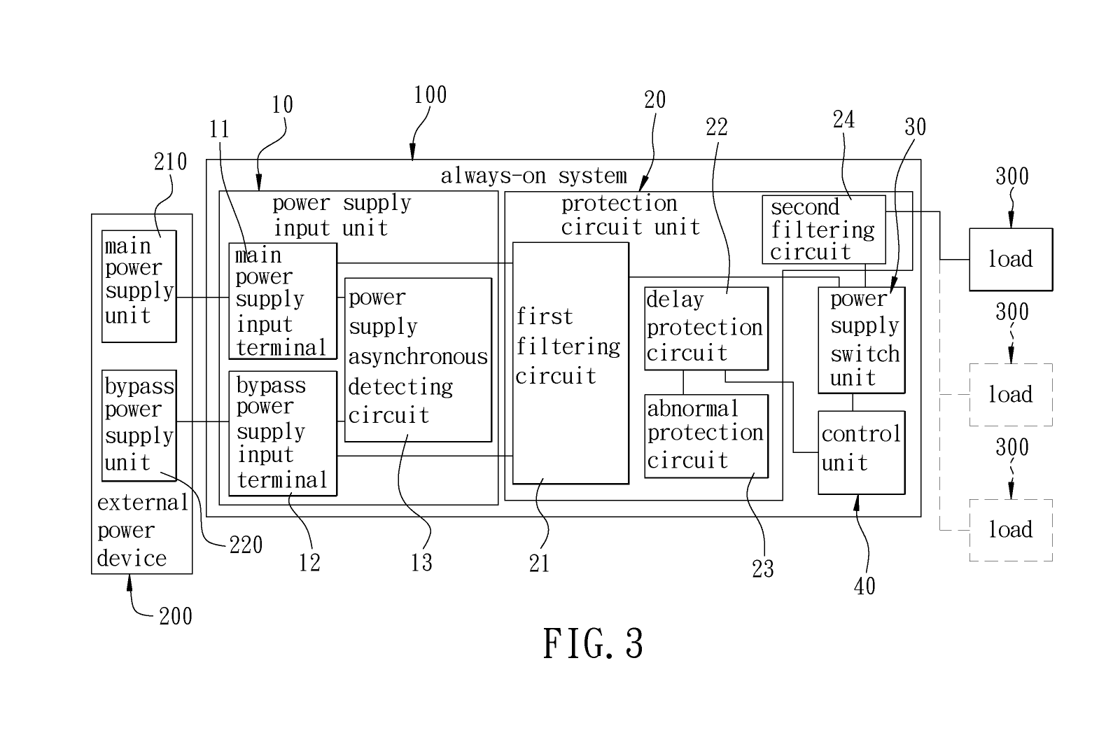

Referring to FIGS. 2 and 3 which show a preferred embodiment of an always-on uninterrupted power system 100 in the present invention, the system 100 is connected to an external power device 200 at one side for providing diverse power supplies, and a plurality of loads 300 at the other end. The external power device 200 is provided with a main power supply unit 210 and a bypass power supply unit 220. The always-on system 100 is mainly composed of a power supply input unit 10, a protection circuit unit 20, a power supply switch unit 30 and a control unit 40 as better shown in FIG. 3.

The power supply input unit 10 is provided with a main power supply input terminal 11, a bypass power supply input terminal 12 and a power supply asynchronous detecting circuit 13, said main power supply input terminal 11 connected to said main power supply unit 210, said bypass power supply input terminal 12 connected to said bypass power supply unit 220, said power supply asynchronous detecting circuit 13 connected with the main power supply input terminal and the bypass power supply input terminal 12 respectively. The power supply asynchronous detecting circuit 13 is employed to detect if the phase of power supply transmitted from the main power supply unit 210 of the external power device 200 connected with the main power supply input terminal 11 is synchronous with that of another power supply transmitted from the bypass power supply unit 220 of the external power device 200 connected with the bypass power supply input terminal 12.

The protection circuit unit 20 connected with said power supply input unit 10 at its one side for protecting said load 300 from being damaged, the protection circuit unit 20 is composed of a first filtering circuit 21, a delay protection circuit 22, an abnormal protection circuit 23 and a second filtering circuit 24. The first filtering circuit 21 is connected with the main power supply input terminal 11 and the bypass power supply input terminal 12 of the power supply input unit 10 respectively to isolate noise of surge and harmonic created inside said always-on system 100, the delay protection circuit 22 is connected with the abnormal protection circuit 23.

The power supply switch unit 30 is connected with the first filtering circuit 21 at its one side and connected with said second filtering circuit 24 at its another side. When power supply is transmitted through the main power supply input terminal 11 connected with the main power supply unit 210, the power supply switch unit 30 can switch to the bypass power supply input terminal 12 connected with the bypass power supply unit 220 to provide power through another power supply, keeping the loads 300 connected with the always-on system 100 operating continuously without any influence. It works on the contrary, as well.

The control unit 40 is connected with the delay protection circuit 22 at its one side and connected with the power supply switch unit 30 at its another side, the control unit 40 able to select the main power supply input terminal 11 or the bypass power supply input terminal 12 to provide power to keep the load 300 operating continuously without being affected when one of the main power supply unit 210 and the bypass power supply unit 220 is being installed or uninstalled.

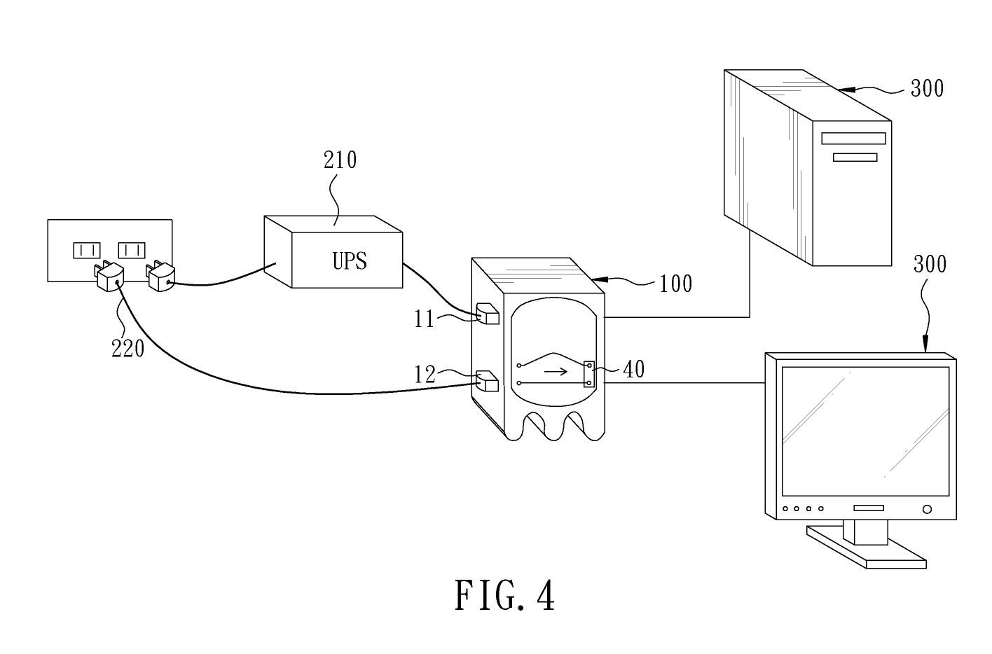

FIG. 4 shows a first example of the preferred embodiment of the present invention in using, wherein the main power supply unit 210 of the external power device 200 is an uninterruptible power system (UPS) connected with the main power supply input terminal 11 of the always-on system 100, and the bypass power supply unit 220 of the external power device 200 is an commercial power directly connected with the bypass power supply input terminal 12. So, the loads 300 are operated by means of the power provided by the always-on system 100 connected therewith. If the main power supply unit 210 is found abnormal to be uninstalled, a user needs only to press down the control unit 40 of the always-on system 100 to make the power supply switch unit 30 switch to the bypass power supply input terminal 12 connected with the bypass power supply unit 220 to provide power for the loads 300 to keep on operating without being shut down for connecting with another power supply, affecting nothing of scheduled work.

After the main power supply unit 210 has been fixed up, it can be directly connected with the main power supply input terminal 11. Then, press down again the control unit 40 to make the power supply switch unit 30 switch back to the main power supply input terminal 11 connected with the main power supply unit 210 to provide power for the loads 300 to go on without being affected. In addition, if a user forgets to switch the bypass power supply input terminal 12 to the main power supply input terminal 11 after having the main power supply unit 210 connected with the main power supply input terminal 11 of the always-on system 100, and the bypass power supply unit 220 stops providing power because of power cut or other unexpected reasons, the abnormal protection circuit 23 sends an enabling signal to the power supply switch unit 30 through the delay protection circuit 22 and the control unit 40, the power supply switch unit 30 is to immediately switch to the main power supply input terminal 11 connected with the main power supply unit 210 (UPS) to provide power for the loads 300, for preventing the loads 300 from damaged owing to man's carelessness.

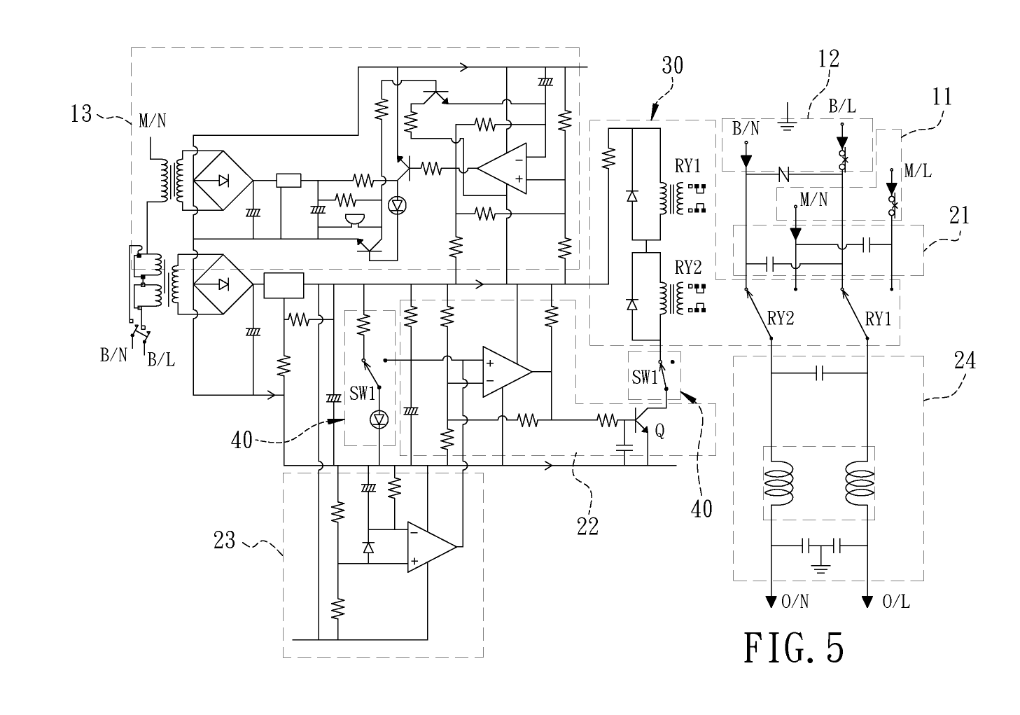

FIG. 5 shows a schematic circuit diagram of the always on uninterrupted power system of the present invention. The system mainly corresponds to the block diagram shown in FIG. 4. The circuit is an actual practiced one with function to achieve the desired ones according to the present invention. It is shown in the circuit, there are main power supply input terminal 11, bypass power supply input terminal 12, power supply asynchronous detecting circuit 13, first filtering circuit 21, delay protection circuit 22, abnormal protection circuit 23, second filtering circuit 24, power supply switching unit 30, and control unit 40 respectively and circuit connection as to the desired function of the always on uninterrupted power system according to the present invention. The power supply switch unit 30 in the preferred embodiment of the present invention is a switch circuit based on relays RY1 and RY2, the control unit 40 in the preferred embodiment of the present invention is synchronous manually switch SW1.

It is better understood with reference to this FIG. 5 for the overall operation of the power switching unit 30. The position of the switch SW1 as shown in FIG. 5 is in the bypass power status. The abnormal protection circuit 23 sends the enabling signal to the delay protection circuit 22, so that the transistor Q will be cut off. The power supply switch unit 30 can automatically switch to the main power supply input terminal 11 connected with the main power supply unit 210 to provide power through another power supply, keeping the loads 300 connected with the always-on system 100 operating continuously without any influence.

If we need to maintain a certain power supply device as specified in block 200 of FIGS. 2 and 3, such as a conventional UPS, we can switch manually. The switch SW1 can be operated manually to switch the power supply either from main power supply unit 210 or bypass power supply unit 220 through the corresponding terminals 11 and 12 respectively, particularly in need to uninstall the UPS.

While the preferred embodiment of the invention has been described above, it will be recognized and understood that various modifications may be made therein and the appended claims are intended to cover all such modifications that may fall within the spirit and scope of the invention.

What is claimed is:

1. An always-on uninterrupted power supply system connected with an external power device at one side of said always-on uninterrupted power supply system for providing diverse power supplies and a load at another side, said external power device comprising a main power supply unit and a bypass power supply unit, comprising:
a power supply input unit provided with a main power supply input terminal, a bypass power supply input terminal and a power supply asynchronous detecting circuit, said main power supply input terminal connected to said main power supply unit, said bypass power supply input terminal connected to said bypass power supply unit, said power supply asynchronous detecting circuit connected with said main power supply input terminal and said bypass power supply input terminal respectively, wherein the power supply asynchronous detecting circuit detecting if a phase of a power supply transmitted from said main power supply input terminal is synchronous with that of another power supply transmitted from said bypass power supply input terminal;
a protection circuit unit connected with said power supply input unit at its one side for protecting said load from being damaged, said protection circuit unit is provided with a first filtering circuit, a delay protection circuit, an abnormal protection circuit and a second filtering circuit, said first filtering circuit connected with said main power supply input terminal and said bypass power supply input terminal of said power supply input unit respectively at its one side to isolate noise of surge and harmonic created inside said always-on system, said delay protection circuit connected with said abnormal protection circuit, said second filtering circuit connected with said load;
a power supply switch unit connected with said first filtering circuit at its one side and connected with said second filtering circuit at its another side; and
a control unit connected with said delay protection circuit at its one side and connected with said power supply switch unit at its another side;
thereby, said control unit able to select said main power supply input terminal or said bypass power supply input terminal to provide power to keep said load operating continuously without being affected when one of said main power supply unit and said bypass power supply unit is being installed or uninstalled, in addition, if said power supply switch unit is switched to said bypass power supply input terminal and said bypass power supply unit stops providing power after having the main power supply unit connected with the main power supply input terminal, the abnormal protection circuit sends an enabling signal to the power supply switch unit through the delay protection circuit and the control unit, said power supply switch unit is to automatically select said main power supply input terminal for being transmitted with external power supply.

2. An always-on uninterrupted power supply system as claimed in claim 1, wherein said control unit is manually switch.

3. An always-on uninterrupted power supply system as claimed in claim 1, wherein said power supply switch unit is a switch circuit based on relays.
